(19) United States
(12) Patent Application Publication
(10) Pub. No.: US 2002/0029309 A1
(43) Pub. Date: Mar. 7, 2002

(54) Warm standby duplexing device and method for operating the same

(75) Inventor: Jin Woo Lee, Anyang-city (KR)

Correspondence Address: FLESHNER & KIM, LLP, P.O. Box 221200, Chantilly, VA, 20153-1200, US

(73) Assignee: LG Electronics Inc.

(21) Appl. No.: 09/920,825

(22) Filed: Aug. 3, 2001

(30) Foreign Application Priority Data
Aug. 4, 2000 (KR) 45259/2000

(51) Int. Cl. G06F 12/00; G06F 13/14; G06F 13/38

(52) U.S. Cl. 710/240

(57) ABSTRACT

A duplex device is disclosed, having: (1) a first device and a second device of the duplex device each having a D-channel controller and a C-channel controller; (2) a D-channel interconnecting the D-channel controllers of the first and second devices to convey at least one of the data signals, the address signals, and the control signals; and (3) a C-channel interconnecting the C-channel controllers of the first and second devices to convey status signals. The C-channel controller of the first and second devices each monitor a subset of the C-channel status signals to determine which of the first and second devices has an active mode status and which has a standby mode status. Both the active mode status and the standby mode status are identified by a self-side normal signal and a pair-side active signal.

### BACKGROUND OF THE INVENTION

1. Field of the Invention

The present invention relates to a system having a duplexing main processor, and more particularly, to a warm standby duplexing device that prevents basic functions of the main processor from being interrupted in a system using a power PC (hereinafter, referred to as PPC) bus and a method for operating the same.

2. Background of the Related Art

Duplexing a system is needed to enhance the reliability of the system. A duplex system has one or more systems that are the same as a main system and are connected to the main system. Based upon an appropriate control method, each system has either an active status or a standby status. The function and performance of the duplex system can be maintained by one of the active or standby systems without a disruption, even if a malfunction in one of the systems.

Where the duplexing system can't provide further service by mounting/demounting the module or by resetting its operation while the main system is operating, it delivers all of the operational rights the main system has to the standby system when the main system fails. As a result, even though trouble occurs in the main system, the duplexing system can provide a communication service, without disruption.

Duplexing technology may be classified in accordance with the volume, driving status and shape of the standby system and the maintenance items of the system. Regarding the driving status of the standby system, duplexing technology is divided into cold, warm and hot standby duplexing. Also, the driving status varies in accordance with the hardware and software configuration of the system. Generally though, the designation of warm and hot standby duplexing is based on the driving status at the time power is applied to the duplex device.

Warm standby duplexing is one of passive duplexing. A warm standby system may develop some trouble in the same manner as the main system, while it is non-active. In standby mode, it may be configured to receive an input but not transmit an output, until a malfunction occurs in the active system. Alternatively, it may carry out an intermediate process for the input received. Since the standby system is operative while the active system is being operative, warm standby duplexing technology makes it possible to carry out multiple processes using a time difference for the loads and to achieve flexible operation of the system.

Warm standby duplexing technology uses a concurrent write manner, under the control of the active system module. Only the active module operates a program. The standby module does not carry out any software operation. Moreover, only the duplexing-related data is continuously updated in the standby memory by the active module. If the active module has an abnormal status, the standby module senses it and reads initialization data from memory (e.g., ROM). For example, where power is first applied and the standby module carries out an initial operation. Since the duplexing-related data is updated by the active module, there is no need for an additional operation by the standby module to update the data.

Hot standby duplexing uses active duplexing. With hot standby duplexing, the standby module receives the same input as the active module and is in a driving status. However, if the active module malfunctions, the standby module is switched in to replace the active module and thereby develops an output used as an output of the whole system. In the same manner as warm standby duplexing, the standby module is operative while the active module is being operative and it can carry out the duplex switching in a simple sensing manner.

Hot standby duplexing operates the same program in the two control modules where duplexing is provided, but the standby module has a hardware blocked data transmission line. Only the active module sends valid data. Since the same program operates in each module, the standby module can be replaced by the active module and vice versa, without any change of time and outer appearance.

Warm standby duplexing needs a lot of time to switch from the standby mode to the active mode. As a result, the basic functions in the system halt momentarily, thereby decreasing the reliability of the system. In a case where there is a large load or where the system is stopped by an interrupt, hot standby duplexing may cause the two modules to enter an abnormal status, thereby exposing the system to many dangers.

FIG. 1 illustrates the configuration of a conventional exchange, wherein the duplexing part between an active mode processor and a standby mode processor is shown. The active mode processor operates in an active mode and the standby mode processor operates in a standby mode. For the convenience of the explanation, the configuration where the two processors operate in the opposite modes is avoided.

The active mode processor is comprised of a central processing unit 11, a duplexing controller 12, an address FIFO 13, an address buffer 14, a data buffer 15, a data FIFO 16, a memory controller 17 and a memory 18. The standby mode processor is comprised of a central processing unit 21, a bus arbiter 22, an address buffer 23, a data buffer 24, a memory controller 25 and a memory 26.

When the central processing unit 11 writes data to the memory 18 and the data is to be duplexed, the duplexing controller 12 stores the address in the address FIFO 13 and the data in data FIFO 16. When the central processing unit 11 reads or writes the data from and to the memory 26 of the standby mode processor or if the address FIFO 13 and the data FIFO 16 are not empty, the duplexing controller 12 requests that the bus arbiter 22 send a bus grant signal. If the bus grant signal is sent, memory 26 of the standby mode processor is read or written via a duplexing channel.

The address FIFO 13 temporarily stores the address of data to be duplexed irrespectively of whether the duplexing controller 12 occupies the processor bus of the standby mode processor to carry out the duplexing process. Similarly, the data FIFO 16 temporarily stores the data to be duplexed irrespectively of whether the duplexing controller 12 occupies the processor bus of the standby mode processor to carry out the duplexing process. Address buffer 14 and data buffer 15 provide the passages to the memory 26 of the standby mode processor at the time the central processing unit 11 reads or writes the data.

The standby mode processor includes the central processing unit 21, the memory controller 25 and the memory 26 as does the active mode processor. It has the bus arbiter 22 for arbitrating the use of the bus between the central processing unit 21 and the duplexing controller 12, at the time of the duplexing. Additionally, it has the data buffer 24 and the address buffer 23 providing the passages for the data and the address to be duplexed.

If the central processing unit 11 of the active mode processor reads data from memory 26 of the standby mode processor, the duplexing controller 12 requests permission from the arbiter 22 to use the bus. If the arbiter 22 responds to the duplex controller 12 with a bus grant, the duplexing controller 12 and the bus arbiter 22, respectively, control address buffers 14 and 23 to provide the passage for the address. Memory controller 25 of the standby mode processor retrieves the addressed data from memory 26 and loads it on the processor bus. The data is sent to the central processing unit 11 via the passage provided by data buffers 24 and 15, which are controlled by the bus arbiter 22 and the duplexing controller 12.

If the central processing unit 11 of the active mode processor writes data to memory 26 of the standby mode processor, the duplexing controller 12 requests the bus arbiter 22 to send a bus grant signal. If the bus grant signal is sent, duplexing controller 12 and bus arbiter 22, respectively, control the address buffers 14 and 23 and data buffers 15 and 24, thereby providing the passages for the address and data. After that, the memory controller 25 of the standby mode processor writes the data sent through the corresponding passages to memory 26.

If the central processing unit 11 of the active mode processor simultaneously writes to both memory 18 and memory 26, the duplexing controller 12 temporarily stores the address and data to the address FIFO 13 and the data FIFO 16. Also, the duplexing controller 12 always monitors the status information of the address FIFO 13 and the data FIFO 16. If the corresponding FIFOs are not empty, the duplexing controller 12 requests the bus arbiter 22 of the standby mode processor to send a bus grant signal. If the bus grant signal is sent, the duplexing controller 12 sends the address and data of the corresponding FIFOs to the standby mode processor side via the duplexing channel. Bus arbiter 22 controls address buffer 23 and data buffer 24 to provide a passage for the address and data. Memory controller 25 of the standby mode processor writes the data sent through the passage to memory 26.

For the above-mentioned exchange, the duplexing channel, between the active mode processor and the standby mode processor, is merely separated from the processor bus in the central processing unit side by the address and data buffers of the standby mode processor. The duplexing channel can be operated only when the duplexing channel has the same clock speed as the processor bus. Where a high performance central processing unit requires a high speed bus, the clock speed of the duplexing channel may fail to match the clock speed. Thereby making it impossible to operate the duplexing channel with a high performance central processing unit.

For example, in executing an operation to copy data stored in memory 26 of the standby mode processor to memory 18 of the active mode processor, writing data to the DRAM in the active mode processor is completed after the reading from the DRAM in the standby mode processor is finished. Additionally, the data write operation is delayed by the time delays of each buffer and by the time delay of the buffer controller, thereby prolonging the standby time in the active mode processor. The active mode processor experiences decreased processing performance due to the standby time.

### SUMMARY OF THE INVENTION

An object of the present invention is to provide a warm standby duplexing device and method for operating it and that prevents basic functions of a module from being interrupted even under abnormal conditions in a system using a PPC bus.

To achieve this object and other advantages and in accordance with the purpose of the invention, as embodied and broadly described herein, there is provided a warm standby duplexing device including: an active module having a central processing unit for carrying out control and data processes; an arbiter for arbitrating the use of a bus; a memory controller for controlling access to a memory; a D-channel controller providing a First-In First-Out (FIFO) type of memory on a duplexing path; a C-channel controller used for exchanging the status and control information of duplexing modules; a standby module having a central processing unit for carrying out control and data processes; an arbiter for arbitrating the use of a bus; a memory controller for controlling the access to a memory; a D-channel controller providing a FIFO memory for accessing the data from the D-channel controller of the active module; a C-channel controller used for exchanging the status and control information of the duplexing modules; a C-channel for exchanging the status and control information between the C-channel controllers of the duplexing modules; and a D-channel for supporting access to the memory of a pair-side module by the D-channel controllers of the duplexing modules.

In another aspect of the present invention, there is provided a method for operating a warm standby duplexing device, which includes the steps of: reading the status of the pair-side module via a C-channel at an active module side, comparing the read result with the status of the active module and determining a direction of a D-channel based upon the compared result; if the D-channel direction is determined, reading only the contents of the self-side memory at the time when the active module reads data from the memory and writing the same data to the self-side memory and the pair-side memory, at the same time, via an address bus and a data bus at the time when the active module writes data; and if an abnormal condition occurs in the active module, recognizing the status of the active module with the standby module using the C-channel, whereby the status of the standby module is switched into the status of the active module.

The objects of the present invention can be achieved in whole or in part by a duplex device is disclosed, having: (1) a first device and a second device of the duplex device each having a D-channel controller and a C-channel controller; (2) a D-channel interconnecting the D-channel controllers of the first and second devices to convey at least one of the data signals, the address signals, and the control signals; and (3) a C-channel interconnecting the C-channel controllers of the first and second devices to convey status signals. The C-channel controller of the first and second devices each monitor a subset of the C-channel status signals to determine which of the first and second devices has an active mode status and which has a standby mode status. Both the active mode status and the standby mode status are identified by a self-side normal signal and a pair-side active signal.

The objects of the present invention can be achieved in whole or in part by a method of implementing a duplexing device that has a first device and a second device, wherein the method includes: (1) reading a first status of the first device and a second status of the second device; (2) setting one of the first and second devices to the active mode and the other of the respective devices to the standby mode based on the first and second status. Both the first status and the second status are identified by a self-side normal signal and a pair-side active signal.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the configuration of the duplexing processors in a related art exchange;

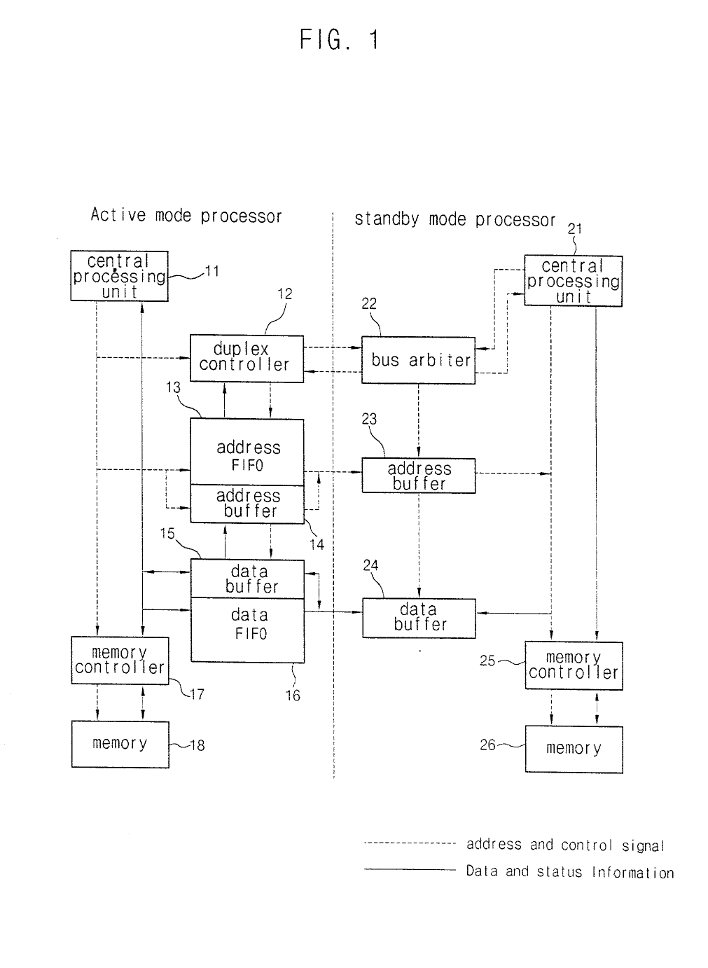

FIG. 2 illustrates a logic configuration of a warm standby duplexing device according to a preferred embodiment of the present invention;

FIG. 3A illustrates the operation of the C-channel of FIG. 2 according to a preferred embodiment of the present invention;

FIG. 3B illustrates a truth table for the C-channel of FIG. 3A;

FIG. 4 illustrates a flowchart of the duplexing control signals, according to a preferred embodiment of the present invention;

FIG. 5 illustrates a flowchart of a read operation by the D-channel of FIG. 2 at the time of duplexing, according to a preferred embodiment of the present invention; and

FIG. 6 illustrates a flowchart of a write operation performed by the D-channel of FIG. 2 at the time of duplexing, according to a preferred embodiment of the present invention.

### DETAILED DESCRIPTION OF PREFERRED EMBODIMENTS

Reference will now be made in detail to the preferred embodiments of the present invention, examples of which are illustrated in the accompanying drawings.

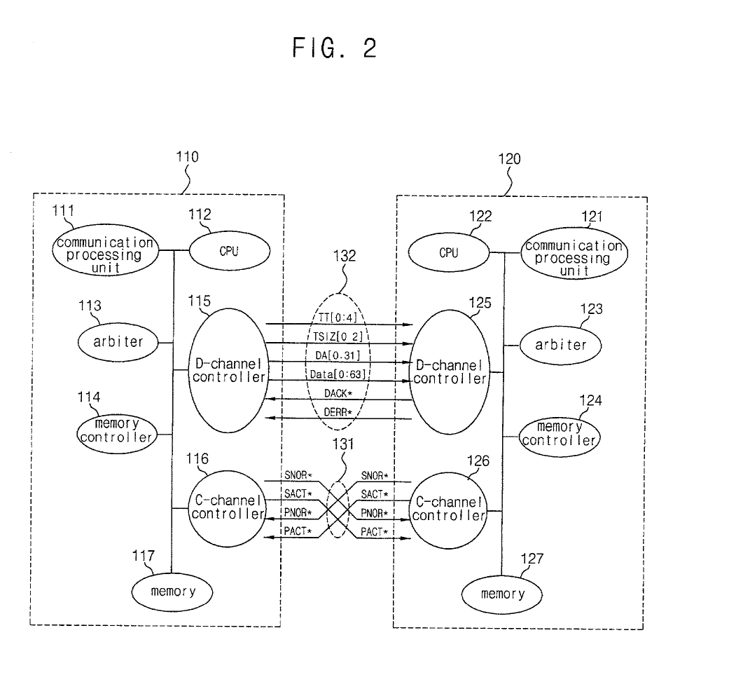

Referring now to FIG. 2, the duplexing logic configuration is formed by the active module 110 and the standby module 120. Interconnecting the duplexing logic configuration, are the D-channel controllers 115 and 125, the C-channel controllers 116 and 126 and the C-channel 131 and the D-channel 132 between the C-channel and D-channel controllers.

Active module 110 is comprised of a communication processing unit 111, a central processing unit 112, an arbiter 113, a memory controller 114, the D-channel controller 115, the C-channel controller 116 and memory 117. Communication processing unit 111 carries out the communication processing with outside devices, central processing unit 112 carries out all kinds of control and data processes in the interior of the module, arbiter 113 arbitrates the use of the memory, controller 114 controls access to the memory 117, D-channel controller 115 controls the reading and writing operations to the pair-side memory via the D-channel 132, and C-channel controller 116 checks the self-side status and the pair-side status via the C-channel 131.

The central processing unit 112, the communication processing unit 111 and the D-channel controller 115 have a master and slave relationship during a bus operation. That is, if one of them is a bus master (which occupies the bus and carries out the bus operation), the other two are bus slaves. Arbiter 113 determines which of the central processing unit 112, the communication processing unit 111 and the D-channel controller 115 is the bus master during a bus operation cycle.

For example, in the state where the central processing unit 112 occupies the bus as the bus master, if the communication processing unit 111 needs to use the bus, the communication processing unit 111 transmits a bus request signal to the arbiter 113. When the central processing unit 112 completes its use of the bus, the arbiter 113 transmits a bus grant signal to the communication processing unit 111. Thereafter, the communication processing unit 111 develops a transfer start signal TS* and sends an address and data. Also, it outputs the address bus busy and data bus busy signals indicating that the two busses are occupied.

Similarly, the standby module 120 is comprised of the communication processing unit 121, the central processing unit 122, the arbiter 123, the memory controller 124, the D-channel controller 125, the C-channel controller 126 and the memory 127. The D-channel 132 is used to maintain data consistency between the duplexing modules 110 and 120. D-channel controller 115 provides a FIFO memory used as a message queue on a duplexing path, where the active module 110 accesses a specific area of the memory 127 of the standby module 120 through a 64-bit parallel data bus of the D-channel 132. The C-channel controller 116 is used to exchange the status and control information of the duplexing modules via the C-channel 131.

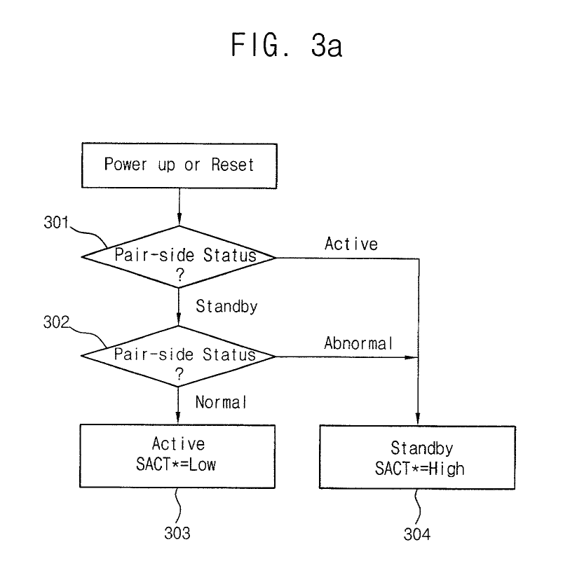

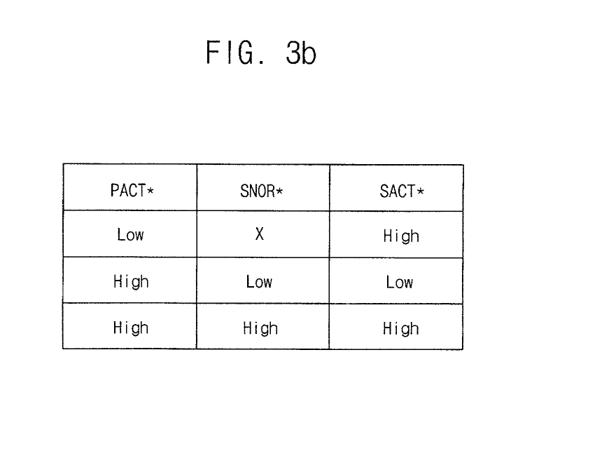

Referring now to FIGS. 2, 3A, and 3B, an explanation of the operation state of the C-channel controllers 116 and 126 will be described. The signals related to the C-channel 131 are a self-side active signal SACT*, a self-side normal signal SNOR*, a pair-side active signal PACT* and a pair-side normal signal PNOR*. These signals cross to be connected with each other and depending upon the side asserted, each of the C-channel controllers 116 and 126 recognizes the self-side signal status SACT* and SNOR* and the pair-side signal status PACT* and PNOR*, thereby determining whether it is in an active or standby mode.

As shown in FIG. 3A, if power is supplied or a reset occurs, each module checks the pair-side status (at step 301). If the pair-side status is standby mode, the module 110, 120 checks the self-side status (at step 302). If the self-side status is normal, the module asserts the self-side active signal SACT* at a low state, thereby setting the self-side status to active mode (at step 303). However, if the pair-side status determined in step 301 is the active mode or if the self-side status determined in step 302 is abnormal, the module 110, 120 asserts the self-side active signal SACT* at a high state, thereby setting the self-side status to standby mode (at step 304).

Therefore, the module 110, 120, that first achieves the normal status asserts the self-side normal signal SNOR* at the low state. Then, the pair-side active signal PACT* and the pair-side normal signal PNOR*, of the pair-side module, transition to the high state. Also, the module 110, 120 that first achieves the normal status sets its self-side status to active mode, thereby outputting the self-side active signal SACT* at the low state.

Even though the standby module 120 transitions to the normal mode and asserts the self-side normal signal SNOR* at the low state, the pair-side normal signal PNOR* and the pair-side active signal PACT* of the pair-side module 110 have been asserted at the low state and are in the active status. As a result, the standby module 120 sets the self-side status to the standby mode and keeps the self-side active signal SACT* at the high state.

Each of the C-channel controllers 116 and 126 checks the pair-side active signal PACT*, via the C-channel 131, and if the pair-side active signal PACT* is at the low state, the self-side active signal SACT* of each controller transitions to the high state. Thereby, the self-side module is in the standby state and the pair-side module is in the active state. When the pair-side module is in the standby state, each module 110, 120 checks the self-side normal signal SNOR*. If the SNOR* signal is in the low state, each module asserts the self-side active signal SACT* at the low state, thereby transitioning to the active mode. And, if the pair-side module is in the active mode or the self-side module is in the abnormal state, the self-side active signal transitions to the high state, such that the self-side module is in the standby mode.

Referring to FIG. 3B, each module asserts the self-side active signal SACT* by itself, thereby indicating whether it is in the active or standby mode. If the self-side active signal is at the high state, then the self-side module is in the standby state. Contrarily, if the self-side active signal is at the low state, the self-side module is in the active state.

Each module asserts the self-side normal signal SNOR* by itself, thereby indicating whether it is in the normal or abnormal state. If the self-side normal signal is at the high state, then the self-side module is in the abnormal state. Contrarily, if the self-side active signal is at the low state, then the self-side module is in the normal state.

Each module 110, 120 asserts the pair-side active signal PACT* by the pair side, thereby indicating whether the pair-side module is in the active or standby state. If the pair-side active signal is at the high state, the pair-side module is in the standby state. Contrarily, if the pair-side active signal is at the low state, the pair-side module is in the active state.

Each module asserts the pair-side normal signal PNOR* by the pair side, thereby indicating whether the pair-side module is in the normal or abnormal state. If the pair-side normal signal is at the high state, the pair-side module is in the abnormal state. Contrarily, if the pair-side normal signal is at the low state, the pair-side module is in the normal state.

Each of the signals SACT*, SNOR*, PACT* and PNOR* related to the C-channel 131 is provided with a pull-up resistor (which is not shown in the drawing). If a signal at a ‘high’ state is sent to one side, a signal at a ‘low’ state is sent to the other side. Therefore, the self-side signal status is determined upon the negotiation result with the pair side.

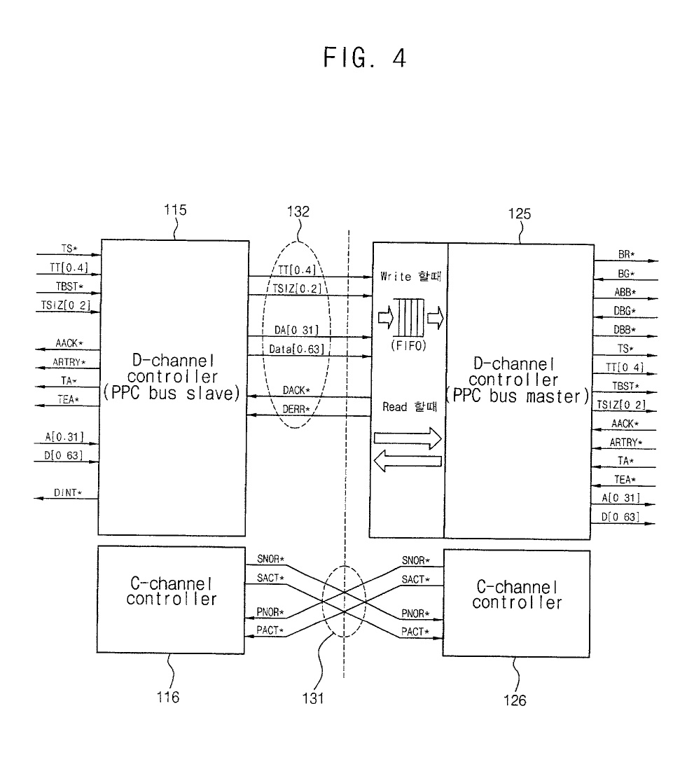

FIG. 4 illustrates a flowchart of the duplexing control signals. Referring to FIGS. 2 and 4, the operation of the control signals in the duplexing processors will be described. At a first step, the active module 110 compares the status of the pair-side module with the self-side status through the C-channel 131. Additionally, the active module 110 checks whether an access is made to the memory of the pair side. In other words, the C-channel controller 116 of the active module 110 reads the status of the pair-side module, obtained through the C-channel 131, and compares the pair-side status with the self-side status, thereby determining whether the active module 110 is in the active state or in the standby state. That is, the active module 110 determines the self-side status based in part on the pair-side status of the standby module 120.

At a second step, the active module 110 accesses the self-side memory 117 and the pair-side memory 127 simultaneously. Writing is executed on both the self-side memory 117 and the pair-side memory 127, at the same time. In other words, while the active module 110 is writing to the self-side memory 117 it determines the direction of the data bus of the D-channel 132, such that it writes the same information to self-side memory 117 and memory 127 of the standby module 120. Therefore, the active module, which is operating normally, writes to the self-side memory 117 and at the same time, writes the same information written to memory 117 to memory 127 of the standby module 120. As a result, data moves from the active module 110 to the standby module 120. Also, the write operation in the standby module is executed at the time the active module executes the write operation.

When the read operation is executed, the active module divides the read operation into two parts: (1) reading from the self-side memory and (2) reading from the pair-side memory. The read operation is distinguished by an address. The address region is divided into two regions. The first region is a common one and the second region is used only for reading from the pair-side memory. Therefore, the active module 110 generally operates on the common region. The active module 110 only uses the second region when a read operation will be executed on the pair-side memory alone.

The D-channel controller 115 of the active module 110 recognizes the read operation addressed to the second region by its address and a transfer type signal TT* and converts the second region address into the address used on the common region. D-channel controller 115 writes the converted address to the memory (FIFO) of the D-channel controller 125 of the standby module 120. In this case, the transfer type signal TT* indicates whether the corresponding operation is the read or write operation. For example, if a signal TT[0:4] is “11100”, “01010”, “01110”, “11010”, “11110”, or “01011”, it means the read operation. If the signal is “10100”, “00010”, “00110” or “10010”, it means the write operation.

The signals related to the D-channel 132 are a 5-bit[0:4] D-channel transfer type signal DTT, a 3-bit[0:2] D-channel transfer size signal DTSIZ, a 32-bit[0:31] D-channel address DA, a 64-bit[0:63] D-channel data signal DD, a D-channel acknowledge signal DACK* and a D-channel error signal DERR. The transfer type signal DTT[0:4], the transfer size signal DTSIZ[0:2], the address signal DA[0:31] and the data signal DD[0:63] are directly written to the memory (FIFO) of the D-channel controller 125 of the standby module 120. The transfer type signal DTT[0:4], the transfer size signal DTSIZ[0:2] and the address signal DA[0:31] are directly transmitted through the standby module's address busses TT[0:4], TSIZ[0;2] and A[0:31], respectively, when the D-channel controller 125 of the standby module 120 executes an address bus operation, thereby reading the data corresponding to the address. The data signal DD is directly transmitted through the standby module's 120 data bus D[0:63], when the D-channel controller 125 of the standby module 120 executes a data bus operation.

If the operation in the D-channel controller 115 is executed normally, the D-channel controller 125 of the standby module 120 sends the D-channel acknowledge signal DACK*. If the operation in the D-channel controller 115 is executed abnormally, the D-channel controller 125 of the standby module 120 sends the error signal DERR*, causing the D-channel interrupt signal DINT* to be sent to the active module 110.

When the active module 110 executes the memory read operation using a common region address, the memory controller 114 only reads either the contents of memory 117 or pair-side memory 127. When the active module 110 executes the memory write operation, it writes the same data to memory 117 and the pair-side memory 127, at the same time, through the address bus A[0:31] and the data bus D[0:61].

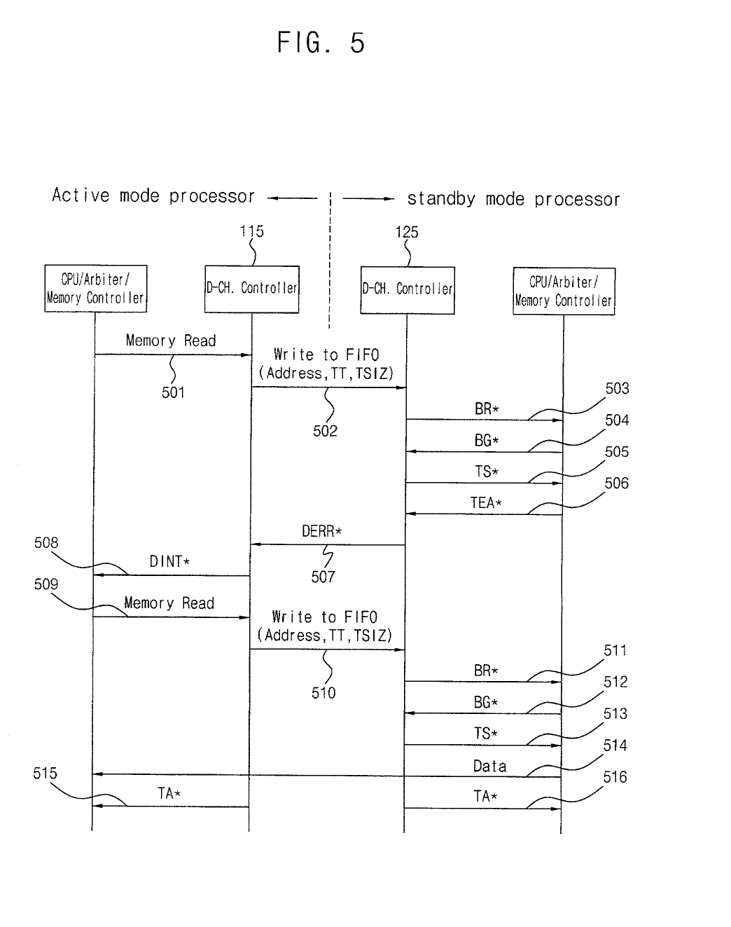

Referring now to FIG. 5, which shows the read operation of the pair-side memory. If the read operation is executed by the central processing unit 112 acting in concert with the arbiter 113 and memory controller 114 of the active module (at step 501), then the D-channel controller 115 writes the address transfer type signal TT* and the transfer size signal TSIZ* to the FIFO of the D-channel controller 125 (at step 502). Afterwards, the pair-side D-channel controller 125 sends a bus request signal BR* to the arbiter 123 (at step 503). If a bus grant signal BG* signal is generated by the arbiter 123 (at step 504), the D-channel controller 125 sends a transfer start signal TS* to the memory controller 124 (at step 505).

If a transfer start error acknowledge TEA* signal is generated by the memory controller 124 due to an abnormal completion (at step 506), the D-channel controller 125 recognizes the signal TEA* and outputs it to the D-channel controller 115 of the active module 110 (at step 507). Upon receiving the TEA* signal, and the D-channel controller 115 of the active module 110 generates the D-channel interrupt signal DINT* (at step 508).

If the D-channel interrupt signal DINT* has been generated (at step 508), the central processing unit 112, the arbiter 113 and the memory controller 114 of the active module 110 generate the memory read signal, again, and output it (at step 509) to the D-channel controller 115. Then, the D-channel controller 115 writes the address and TT and TSIZ signals to the FIFO of the D-channel controller 125 (at step 510) and the D-channel controller 125 generates the bus request signal BR* to the arbiter 123 (at step 511). If an empty flag signal EF* of the FIFO memory of D-channel controller 125 is asserted to the high state, and the bus grant signal BG* is generated (at step 512), the D-channel controller 125 starts the transfer operation (at steps 513 and 514). When the transfer operation is completed normally, the data transferred from the memory of the standby module is read by the memory controller 114 of the active module 110, via the D-channel 132 (at step 515). Thereafter, if the read operation from the pair-side memory is completed, each of the D-channel controllers 115 and 125 generates a transfer acknowledge signal (at step 515 and 516).

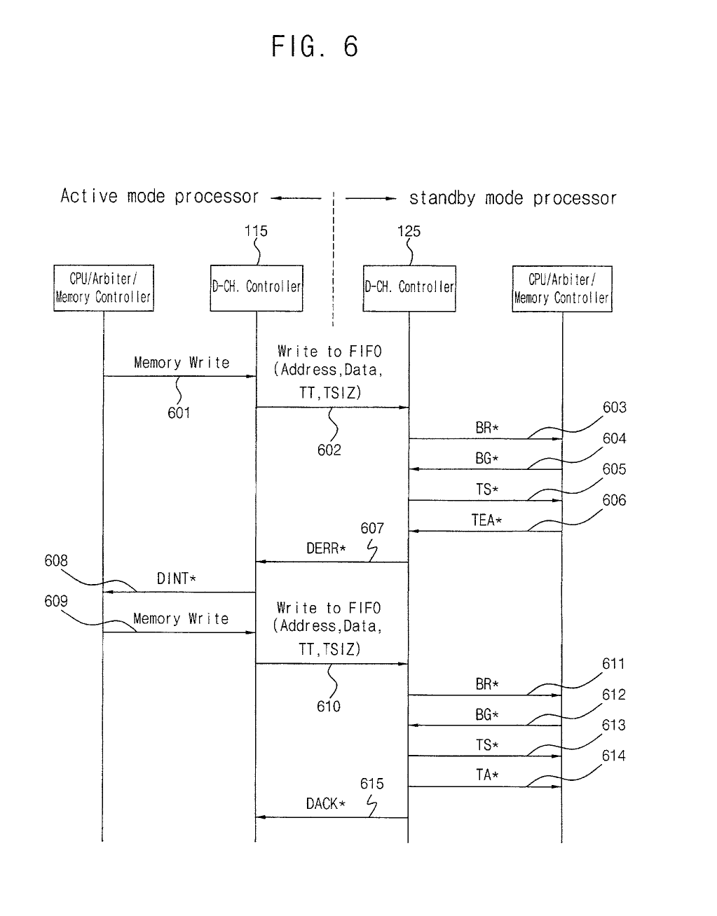

Referring now to FIG. 6, the write operation to the pair-side memory will be described. If a memory write operation is carried out by means of the central processing unit 112, the arbiter 113, and the memory controller 114 of the active module 110 (at step 601), the D-channel controller 115 writes the address, data and the TT and TSIZ signals to the FIFO of the D-channel controller 125 of the standby module 120 (at step 602). The D-channel controller 125 of the standby module 120 generates the bus request signal BR* to the arbiter 123. If the empty flag signal EF* of the memory is outputted to the high state and if the bus grant signal BG* is generated by the arbiter 123, D-channel controller 125 outputs the transfer start signal TS* (at steps 603 to 605).

If the transfer error acknowledge TEA* signal is inputted to the D-channel controller 125 (at step 606), the D-channel controller 125 generates the D-channel error signal DERR* and outputs it to the D-channel controller 115 of the active module 110 (at step 607). The D-channel controller 125 recognizes the TEA* signal and sends the D-channel interrupt signal DINT* to the internal memory controller 114 (at step 608).

If the D-channel interrupt signal DINT* has been generated by the pair side, at the time of the concurrent write operation, the central processing unit 112, the arbiter 113 and the memory controller 114 of the active module 110 output the memory write signal to the D-channel controller 115 (at step 609), again. Next, the D-channel controller 115 writes the signals DA, DD, TT and TSIZ to the FIFO of the D-channel controller 125 (at step 610). The D-channel controller 125 of the standby module 120 generates the bus request signal BR* and sends it to the arbiter 123. If the bus grant signal BG* is generated, D-channel controller 125 starts the transfer operation (at steps 611 to 613). If a receiving check signal is inputted (at step 614), the D-channel controller 125 outputs the receiving check signal to the D-channel controller 115 of the active module 110 (at step 615).

In a case where an abnormal situation occurs in the active module 110, the standby module 120 is switched to act as the active module by changing its status to active mode. When the standby module 120 becomes the active status module, the active module 110 is preferably reset to overcome its abnormality. The application of the reset is delayed and an interrupt is generated. During the delay, the D-channel controller 115 of the active module 110 transmits its register information to the FIFO of the D-channel controller 125 of the standby module 120 in burst mode and executes a write operation. After that, the C-channel controller 116 asserts the self-side normal signal SNOR* at the high state and the self-side active signal SACT* to the high state. Then, the standby module 120 asserts the self-side normal signal SNOR* at the low state and the self-side active signal SACT* at the low state in response to the pair-side normal signal PNOR* and the pair-side active signal PACT* changing to the high state. In this way, the standby module 120 is switched to active mode and the active module 110 is switched to standby mode.

As described above, a warm standby duplexing device according to a preferred embodiment the present invention prevents basic functions of a module from being interrupted, even under abnormal situations, in a system using a PPC bus.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A duplex device, comprising:
an active module having a primary central processing unit that carries out control and data processes, a primary arbiter that arbitrates the use of a primary bus, a primary memory controller that controls access to a primary memory, a primary D-channel controller that provides a primary first-in first-out (FIFO) memory for the communication of parallel data on a duplexing path, and a primary C-channel controller that communicates primary status information of the active module;
a standby module having a secondary central processing unit that carries out control and data processes, a secondary arbiter that arbitrates the use of a secondary bus, a secondary memory controller that controls access to a secondary memory, a secondary D-channel controller that provides a second FIFO memory for the communication of the parallel data on the duplexing path, and a secondary C-channel controller that communicates secondary status information of the standby module;
a C-channel that exchanges the primary and secondary status information between the primary and secondary C-channel controllers to support duplexing logic between the active module and the standby module; and
a D-channel that supports access to the primary and secondary memories by both the primary and secondary central processing units.

2. The duplex device of claim 1, wherein each of the primary and secondary C-channel controllers identifies the primary status information and the secondary status information, based on the values of a self-side active signal, a self-side normal signal, a pair-side active signal, and a pair-side normal signal, and determines which one of the active and standby modules is operating in an active mode and which is operating in a standby mode.

3. The duplex device of claim 2, wherein:
the self-side active signal transmitted by the primary C-channel controller is designated as the pair-side active signal, when received by the secondary C-channel controller;
the self-side normal signal transmitted by the primary C-channel controller is designated as the pair-side normal signal, when received by the secondary C-channel controller;
the self-side active signal transmitted by the secondary C-channel controller is designated as the pair-side active signal, when received by the primary C-channel controller; and
the self-side normal signal transmitted by the secondary C-channel controller is designated as the pair-side normal signal, when received by the primary C-channel controller.

4. The duplex device of claim 2, wherein each of the primary and secondary D-channel controllers obtains the primary status information and secondary status information, from the primary or secondary C-channel controller of its respective one of the active or standby modules and executes a duplexing operation, as a master or a slave of a Power Personal Computer (PPC) bus, in a communication direction of the D-channel determined by a comparison of the primary status information and the secondary status information.

5. A method of operating a duplex device, comprising:
(a) reading a secondary status of a secondary module, via a C-channel, with a primary module, comparing the secondary status with a primary status of the primary module to obtain a first result, determining a direction of a D-channel based upon the value of the first result, and determining which one of the primary and secondary modules is an active module based upon the value of the first result;
(b) reading only the contents of a first memory in the active module to a processor within the active module that requested the contents, when the processor performs a memory read operation of the first memory, and concurrently writing data to the first memory and to a second memory in the one of the primary and secondary modules that is not the active module and is, therefore, designated a standby module, when the processor performs a memory write operation; and
(c) recognizing, with the standby module, that a fault has occurred in the active module by identifying an abnormal signal communicated by a C-channel controller of the active module, changing the active module to a standby mode of operation;
(d) changing the standby module to an active mode of operation;
(e) changing the primary module or the secondary module that has the active mode of operation to be the active module; and
(f) changing the primary module or the secondary module that has the standby mode of operation to be the standby module.

6. The method of claim 5, wherein the active module executes the memory write operation to the second memory, via the D-channel, and each of a primary D-channel controller and a secondary D-channel controller executes a duplexing operation, while serving as a master or slave in a power PC (PPC) bus.

7. The method of claim 5, wherein step (b) further comprises:
analyzing a transfer type signal and an address in a first D-channel controller of the active module to obtain a second result;
if the second result is determined to be the memory read operation addressed to the first memory, reading the addressed contents only from the first memory and if the second result is determined to be either the memory write operation or the memory read operation addressed to the second memory, writing the address, the transfer type signal, and a transfer size signal from a first FIFO memory of the first D-channel controller to a second FIFO memory of a second D-channel controller of the standby module;
when an empty flag signal is asserted from the second FIFO memory, sending a bus request signal from the second D-channel controller to a bus arbiter of the standby module and receiving a bus grant signal at the second D-channel controller from the bus arbiter;
after the bus grant signal is received, generating a transfer start signal from the second D-channel controller to a second memory controller of the standby module and transmitting the address to the second memory via an internal bus operation of the standby module; and
if an operation completion signal is generated from the second memory controller, returning the bus grant signal to the bus arbiter.

8. The method of claim 7, wherein the first FIFO memory writes the address, the transfer type signal and the transfer size signal to the second FIFO memory during the memory read operation.

9. The method of claim 7, wherein the address determines whether the contents are read from the first memory or the second memory.

10. The method of claim 9, wherein an address region is divided into two regions, wherein a first region of the two regions comprises memory addresses common to both the first memory and the second memory and a second region of the two regions comprises memory addresses used only for reading from the second memory.

11. The method of claim 10, wherein the first D-channel controller recognizes both the memory read operation having the second region address and the transfer type signal and converts the second region address into a corresponding first region address and writes the corresponding first region address to the second FIFO memory.

12. The method of claim 7, wherein the first FIFO memory, at the time of the memory write operation, writes the address, the transfer type signal and the transfer size signal to the second FIFO memory and the second D-channel controller transmits the address via an internal bus of the standby module.

13. The method of claim 7, wherein if the memory read operation or the memory write operation is completed abnormally, the second D-channel controller inputs a transfer error acknowledge signal and asserts a D-channel error signal to the first D-channel controller, thereby generating a D-channel interrupt signal to the active module.

14. The method of claim 7, wherein if the memory read operation from the second memory is completed normally, the first D-channel controller communicates a primary transfer completion message to a first memory controller of the active module and the second D-channel controller comnmunicates a secondary transfer completion message to the second memory controller.

15. The method of claim 7, wherein if the memory write operation to the second memory is completed normally, the second D-channel controller informs the first D-channel controller of a write completion.

16. The method of claim 5, wherein step (c) further comprises:
generating an interrupt in the active module, if the fault occurs;
if the interrupt is generated in the active module, writing register information of a first D-channel controller, during a delay time, to a second FIFO memory of a second D-channel controller in a burst mode;
if the write operation in the burst mode is completed, asserting a self-side abnormal status and a first self-side active status of the C-channel controller of the active module to a high state and transmitting an assert signal to the second D-channel controller; and
asserting a second self-side active signal of the standby module to a low state; and
changing the standby module to the active mode of operation.

17. A duplex device, comprising:
a first device and a second device of the duplex device each having a D-channel controller and a C-channel controller;
a D-channel interconnecting the D-channel controllers of the first and second devices to convey at least one of data signals, address signals, and control signals; and
a C-channel interconnecting the C-channel controllers of the first and second devices to convey status signals, wherein
the C-channel controller of the first and second devices each monitor a subset of the C-channel status signals to determine which of the first and second devices has an active mode status and which has a standby mode status, and
both the active mode status and the standby mode status are identified by a self-side normal signal and a pair-side active signal.

18. The duplex device of claim 17, wherein:
the active mode status is identified by a true state existing on the self-side normal signal and a false state existing on the pair-side active signal, and
the standby mode status is identified by other combinations of the true and false states existing on the self-side normal and pair-side active signals.

19. The duplex device of claim 18, wherein:
whichever one of the first and second devices that has the active mode status, generates the address signals conveyed by the D-channel.

20. The duplex device of claim 18, wherein each of the first and second devices share a common address bus and a common data bus and further comprises:
a communication processor that communicates input and output I/O) information between the duplex device and external devices;
a central processing unit that controls communication processes within the respective first and second devices;
a memory that stores retained information;
an arbiter that arbitrates the use of the common data bus, wherein
one of the first and second devices has the active mode status to generate the address signals conveyed by the D-channel and to control a read access and a write access to each memory of the first and second devices.

21. The duplex device of claim 20, wherein:
within both of the first and second devices, respectively, the communication processor, the central processing unit, the memory, and the D-channel controller share the common data bus and the common address bus.

22. A method of implementing a duplex device that has a first device and a second device, comprising:
reading a first status of the first device and a second status of the second device;
setting one of the first and second devices to an active mode status and the other of the respective devices to a standby mode status based on the first and second status, wherein
both the first status and the second status are identified by a self-side normal signal and a pair-side active signal.

23. The method of claim 22, wherein:
the active mode status is identified by a true state existing on the self-side normal signal and a false state existing on the pair-side active signal, and
the standby mode status is identified by other combinations of the true and false states existing on the self-side normal and pair-side active signals.

24. The method of claim 22, wherein:
the first and second devices each have a communication processing unit, a central processor, a memory, and a D-channel controller, which share both a common address bus and a common data bus;
the first and second devices each have a C-channel controller that communicates with the central processor of the respective first and second devices;
a D-channel interconnects the D-channel controllers of the first and second devices to convey data signals, address signals, and control signals; and
a C-channel interconnects the C-channel controllers of the first and second devices to convey the first and second status between the first and second C-channel controllers, wherein
one of the first and second devices has the active mode status to generate the address signals conveyed by the D-channel and to control a read access and a write access to the memories of both the first and second devices.
